(19) United States
(12) Patent Application Publication
(10) Pub. No.: US 2009/0119336 A1
(43) Pub. Date: May 7, 2009

(54) APPARATUS AND METHOD FOR CATEGORIZING ENTITIES BASED ON TIME-SERIES RELATION GRAPHS

(75) Inventors: Liqin XU, Beijing (CN); Changjian HU, Beijing (CN); Toshikazu FUKUSHIMA, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD., Beijing (CN)

(21) Appl. No.: 12/261,820

(22) Filed: Oct. 30, 2008

(30) Foreign Application Priority Data
Nov. 2, 2007 (CN) 2007-10169206.7

(51) Int. Cl. G06F 17/30

(52) U.S. Cl. 707/104.1; 707/E17.044

(57) ABSTRACT

The present invention provides an apparatus and a method for categorizing entities based on time-series relation graphs. In each of the time-series relation graphs within a prescribed time period, nodes represent entities, and links between the nodes represent entity relations in a corresponding time unit. The inventive apparatus for categorizing entities based on time-series relation graphs comprises: a time-series relation graph categorizing means for categorizing the nodes in each of the time-series relation graphs to generate a node category result for the corresponding time unit in time sequence; and a category result post-processing means for post-processing all the node category results for the corresponding time units in time sequence generated by the time-series relation graph categorizing means to generate finally categorized nodes.

### BACKGROUND OF THE INVENTION

1. Field of Invention

The present invention relates to the data mining field, and more particularly, to time-series relation mining. According to the present invention, an apparatus and a method for categorizing entities based on time-series relation graphs are provided.

2. Description of Prior Art

With the rapid development of globalization, more complicated business relations are formed among corporations than ever. Further, a developing process of a corporation is much faster than ever, during which other corporations having business relations with it play a critical role in its development.

On the other hand, with developing of informatization, a large amount of business news occurs in mediums such as Internet. These pieces of business news contain a lot of information about business relations among corporations. All the business news accumulated heretofore may cover almost all the information about business relations in all industries. These pieces of information form a time-series business information process. If a business consultation trade may obtain the information therefrom, create a time-series business information process from the information, and derive some relations of the industries and sub-industries as well as some corresponding business events useful for users, which mainly are corporation consulters, then it is a promising technology.

The business relations form a varying network over time. After a time-series model is created for the varying network, there is a problem how to find an industry structure (that is, how many industries are included, how many sub-industries are included in each of the industries, and who is a representative corporation in each of the industries and in each of the sub-industries) therefrom.

Generalizing the business relation to a general relation such as social relation, after a time-series relation graph is given, there is a problem how to determine which nodes belong to a category, how to divide a category into sub-categories and how to find a representative of each category and each sub-category therefrom.

In existing methods, there are technologies for categorizing connection-graph-based relations, such as those described in reference 1, C. H. Ding, X. He, H. Zha, M. Gu, and H. D. Simon, A min-max cut algorithm for graph partitioning and data clustering, Proceedings of IEEE ICDM 2001, pp. 107-114, 2001, and in reference 2, J. Shi and J. Malik, Normalized cut and image segmentation, IEEE Trans. on Pattern Analysis and Machine Intelligence, 22(8): 888-905, August 2000. However, these technologies only apply to simple graphs, and there is no method for categorizing the graphs created for the time-varying business relations.

Further, in detecting business events, there is a technology for detecting important nodes based on time sequence, such as that disclosed in Japanese Patent No. JP 2005-352817. However, there is no technology for detecting events after categorizing a time-series graph into industries.

### SUMMARY OF THE INVENTION

The present invention creates time-series relation graphs for time-varying relations, performs graph-partition-based categorizing on the time-series relation graphs, and then carries out post-processing, so as to achieve finally categorized nodes and corresponding relations.

Also, when the present invention is applied to the business field, corporations and relations in the business field are further divided in terms of industries based on the categorized nodes and relations, and finally business events are obtained by detecting business event in the individual industries.

To achieve the above object, the present invention provides an apparatus for categorizing entities based on time-series relation graphs, wherein in each of the time-series relation graphs within a prescribed time period, nodes represent entities, and links between nodes represent entity relations in a corresponding time unit, the apparatus for categorizing entities based on time-series relation graphs comprising: a time-series relation graph categorizing means for categorizing the nodes in each of the time-series relation graphs to generate a node category result for the corresponding time unit in time sequence; and a category result post-processing means for post-processing all the node category results for the corresponding time units in time sequence generated by the time-series relation graph categorizing means to generate finally categorized nodes.

Preferably, the apparatus for categorizing entities based on time-series relation graphs further comprises: a time-series relation graph generating means for processing inputted relation instances to generate corresponding time-series relation graphs.

Preferably, the time-series relation graph generating means comprises: a time-series relation generating unit for calculating scores for the relation instances, resolving internal conflicts, performing interpolation on absent time points, to obtain time-series relations; a relation synthesizing unit for synthesizing various types of the time-series relations among entities generated by the time-series relation generating unit to obtain respective time-series comprehensive relations between respective two entities; and a time-series relation graph creating unit for creating one graph for the relations for each time unit within the prescribed time period so as to form the time-series relation graphs.

Preferably, the time-series relation graph categorizing means performs categorization on the nodes in the time-series relation graph for each time unit by using a hierarchical categorizing method.

Preferably, the category result post-processing means comprises: a category result mapping unit for mapping each category of all the node category results for the corresponding time units in time sequence generated by the time-series relation graph categorizing means to obtain a merged node category structure; a node occurrence counting unit for counting, for each category of the merged node category structure, the occurring times of each node therein based on the merged node category structure generated by the category result mapping unit and a mapping relation of each node category result therewith; and a node categorizing unit for allocating each node to a corresponding category of the merged node category structure based on the counting result of the node occurrence counting unit.

Preferably, the category result post-processing means further generates a merged node category result, and the apparatus for categorizing entities based on time-series relation graphs further comprises: an event detecting means for performing event detection on the entity relations based on the merged node category result and outputting event results.

Preferably, the entities are corporations, the relations are business relations, and the categories are industries.

To achieve the above object, the present invention provides an method for categorizing entities based on time-series relation graphs, wherein in each of the time-series relation graphs within a prescribed time period, nodes represent entities, and links between nodes represent entity relations in a corresponding time unit, the method for categorizing entities based on time-series relation graphs comprising: a time-series relation graph categorizing step of categorizing the nodes in each of the time-series relation graphs to generate a node category result for the corresponding time unit in time sequence; and a category result post-processing step of post-processing all the node category results for the corresponding time units in time sequence generated in the time-series relation graph categorizing step to generate finally categorized nodes.

Preferably, the method for categorizing entities based on time-series relation graphs further comprises: a time-series relation graph generating step of processing inputted relation instances to generate corresponding time-series relation graphs.

Preferably, the time-series relation graph generating step comprises: a time-series relation generating sub-step of calculating scores for the relation instances, resolving internal conflicts, performing interpolation on absent time points, to obtain time-series relations; a relation synthesizing sub-step of synthesizing various types of the time-series relations among entities generated in the time-series relation generating sub-step to obtain respective time-series comprehensive relations between respective two entities; and a time-series relation graph creating sub-step of creating one graph for the relations for each time unit within the prescribed time period so as to form the time-series relation graphs.

Preferably, in the time-series relation graph categorizing step, categorization on the nodes in the time-series relation graph for each time unit is performed by using a hierarchical categorizing method.

Preferably, the category result post-processing step comprises: a category result mapping sub-step of mapping each category of all the node category results for the corresponding time units in time sequence generated in the time-series relation graph categorizing step to obtain a merged node category structure; a node occurrence counting sub-step of counting, for each category of the merged node category structure, the occurring times of each node therein based on the merged node category structure generated in the category result mapping sub-step and a mapping relation of each node category result therewith; and a node categorizing sub-step of allocating each node to a corresponding category of the merged node category structure based on the counting result of the node occurrence counting sub-step.

Preferably, in the category result post-processing step, a merged node category result is further generated, and the method for categorizing entities based on time-series relation graphs further comprises: an event detecting step of performing event detection on the entity relations based on the merged node category result and outputting event results.

Preferably, the entities are corporations, the relations are business relations, and the categories are industries.

According to the present invention, the following technical problems are efficiently solved:

Creating the time-series relations from the time-varying relation instances, and categorizing the nodes; and

Performing business event detection based on the time-series business relations and the results of categorizing the same.

### BRIEF DESCRIPTION OF THE DRAWINGS

The above and further objects, features and advantages of the present invention will be more apparent from the following description of the preferred embodiments thereof with reference to the drawings, wherein:

FIG. 1a is an overall block diagram showing a system for categorizing and analyzing time-series relations;

FIG. 1b is an overall block diagram showing a system for categorizing and analyzing time-series business relations;

FIG. 2a is a block diagram and also a data flow chart showing a time-series relation graph generating module 2;

FIGS. 2b-2e show illustrations of detailed time-series relations and time-series comprehensive relation graphs (hereinafter, the time-series comprehensive relation graph is referred to as “time-series relation graph”) generated by the time-series relation generating unit 21 during processing, wherein FIGS. 2b and 2c are respectively the illustration of the detailed time-series relations and the comprehensive relation graph at time point t₁, and FIGS. 2d and 2e are respectively the illustration of the detailed time-series relations and the comprehensive relation graph at time point t₂;

FIG. 3a shows an example of a category result;

FIGS. 3b and 3c show the category result at time point t₁ corresponding to FIG. 2c and the category result at time point t₂ corresponding to FIG. 2e, respectively;

FIG. 4a is a block diagram and also a data flow chart showing a category result post-processing module 4;

FIG. 4b shows a merged category result corresponding to FIGS. 3b and 3c;

FIG. 5 is a block diagram and also a data flow chart showing an industry based business event detecting module 6;

FIG. 6 is a block diagram and also a data flow chart showing a business event detecting unit 63; and

FIG. 7 is a block diagram and also a data flow chart showing a time-series corporation relation extracting sub-module 22″ as shown in FIG. 3 of attorney docket No. IA078650.

### DETAILED DESCRIPTION OF PREFERRED EMBODIMENTS

The preferred embodiments of the present invention are described in detail hereinafter with reference to the drawings. Details and functions which are not necessary for the present invention are omitted so as not to confuse the understanding of the present invention. Further, in the following description, an apparatus and a method for categorizing entities based on time-series relation graphs according to the present invention are described in detail with corporations as an example of the entities and business relations as an example of the relations. It is to be noted, however, that the entities set forth in the present invention are not limited to the corporations, and may represent entities such as natural persons, nations or products. Accordingly, the relations set forth in the present invention are not limited to the business relations, and may be applicable to other social relations such as human relations and relations among nations.

System Overview

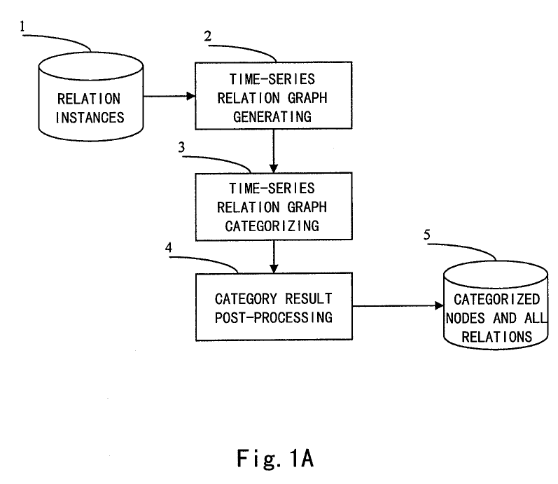

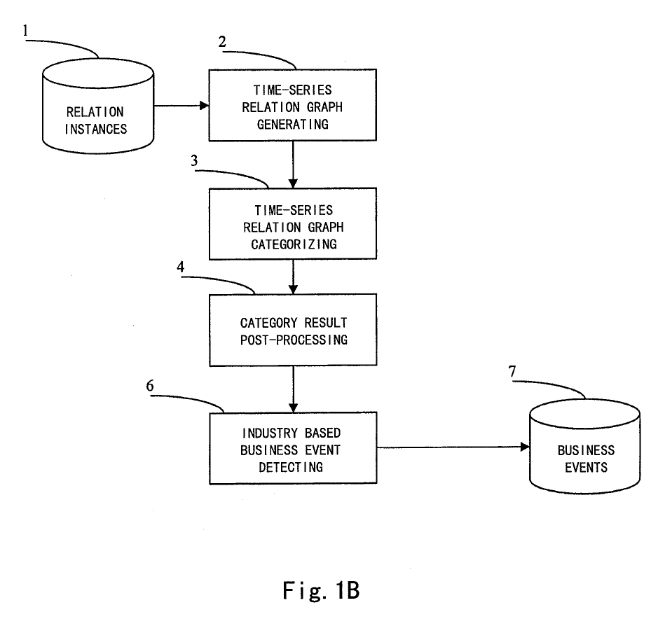

FIG. 1a is an overall block diagram showing a system for categorizing and analyzing time-series relations according to the first embodiment of the present invention. The reference symbol 1 denotes inputted relation instances. A time-series relation graph generating module 2 processes the inputted relation instances 1 to generate corresponding time-series relation graphs. A time-series relation graph categorizing module 3 categorizes the time-series relation graphs generated by the time-series relation graph generating module 2 to generate a category result for each time unit in time sequence. A category result post-processing module 4 post-processes the category results generated by the time-series relation graph categorizing module 3 to generate a time-series comprehensive category result and generate finally categorized nodes and relations.

Detailed Description of the Modules

The relation instance 1 means that there is a relation between two entities, and has the following data structure.

TABLE 1
Example of data structure of entity relation instance

Entity A
Entity B
Type of relation
Time point (such as date)
Source (optional)

For example, in the business field, the entity may represent a corporation, and the type of relation may be competition, cooperation, share holding, supply, incorporation, acquisition and so on. In the following expressions, RI(A,B,X,t′) is used to denote a relation instance, which means that there is a relation instance X between entity A and entity B at time point t′.

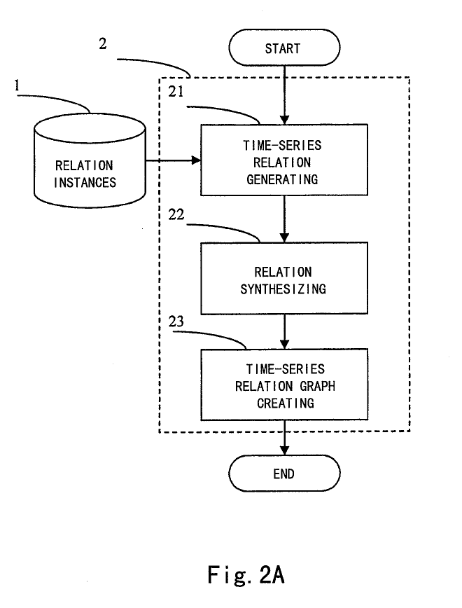

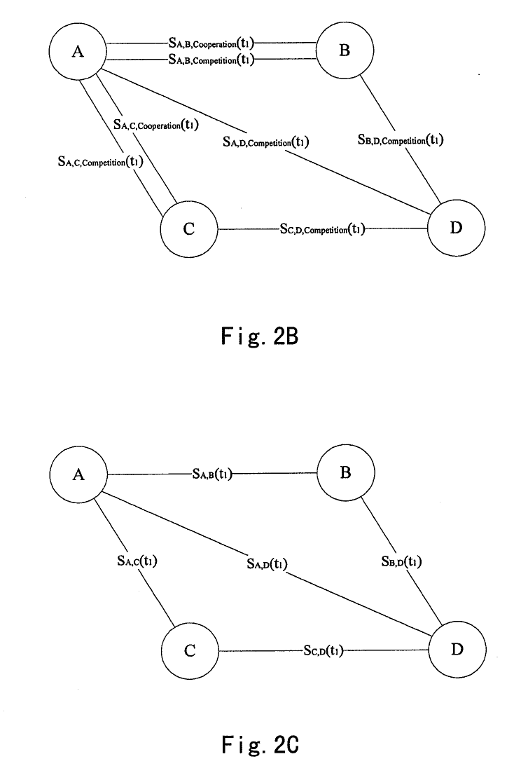

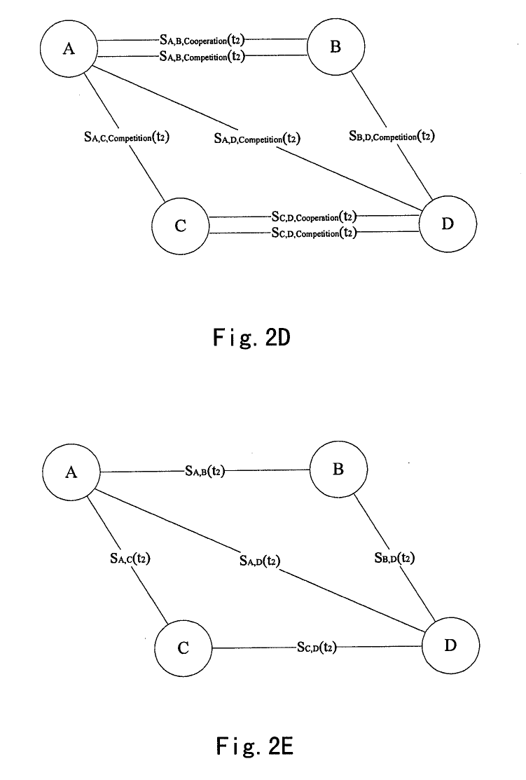

A block diagram and a data flow chart of the time-series relation graph generating module 2 are shown in FIG. 2a.

Specifically, a time-series relation generating unit 21 calculates scores for the relation instances, resolves internal conflicts, and performs interpolation on absent time points so as to obtain time-series relations. These steps may be implemented by existing methods, such as a business relation mining apparatus and method as described in attorney docket No. IA078650. It is to be noted, however, that the business relation is only an example of the relations involved in the present invention, and is not intended to limit the scope of the present invention. Finally, various types of time-series entity relations with scores are obtained. That is, within a period of a prescribed time unit, there is a type of time-series relation as well as a score thereof between two entities, wherein the score refers to a credibility at which there exists this relation during such time unit. An example of the data structure thereof is shown in Table 2.

TABLE 2
Example of data structure of time-series relations generated by the
time-series relation generating unit 21

Corporation A
Corporation B
Type of relation
{(month, score), (month, score), . . . }

s_{A,B,X}(t) is used to denote the score for the business relation X between entity A and entity B in the time unit t.

For example, FIGS. 2b and 2d show illustrations of the detailed time-series relations generated by the time-series relation generating unit 21, wherein, FIG. 2b illustrates the detailed relations at time point t₁, and FIG. 2b illustrates the detailed relations at time point t₂. Specifically, in FIG. 2b, it is shown that there are relations of “Cooperation” and “Competition” between entity A and entity B at time point t₁; there are relations of “Cooperation” and “Competition” between entity A and entity C at time point t₁; there is a relation of “Competition” between entity A and entity D at time point t₁; there are a relation of “Competition” between entity B and entity D at time point t₁; and there are a relation “Competition” between entity C and entity D at time point t₁. In FIG. 2d, it is shown that there are relations of “Cooperation” and “Competition” between entity A and entity B at time point t₂; there are a relation of “Competition” between entity A and entity C at time point t₂; there are a relation of “Competition” between entity A and entity D at time point t₂; there are a relation of “Competition” between entity B and entity D at time point t₂; and there are relations of “Cooperation” and “Competition” between entity C and entity D at time point t₂.

A relation synthesizing unit 22 synthesizes the various types of time-series entity relations to obtain time-series comprehensive relations between respective two entities. s_{A,B}(t) is used to denote the comprehensive relation between two entities. This comprehensive relation is undirected, that is, s_{A,B}(t)=s_{B,A}(t). For example, the comprehensive relation between the corporations represents how close the corporations associate with each other. The closer two corporations associate with each other, it is more possible for them to belong to one industry or sub-industry. The comprehensive relations may be calculated by accumulating the various types of relations using a number of summing methods or weighted summing methods. The calculating formula is show as follows.

$${s}_{A , B} ( t ) = g ( {\sum }_{X} ( {f}_{X} ( {s}_{A , B , X} ( t ) , {s}_{B , A , X} ( t ) ) ) )$$

Wherein fₓ( ) is any monotonously increasing function or monotonously decreasing function corresponding to relation X, and g( ) is any monotonously increasing function for standardizing or normalizing the final score.

An example of the above function is provided as follows.

$${s}_{A , B} ( t ) = {\sum }_{X} ( w ( X ) \cdot {s}_{A , B , X} ( t ) + w ( X ) \cdot {s}_{B , A , X} ( t ) )$$

Wherein w(X) is the weight of the respective relation, which may be an experience value or may be obtained by a statistical method. For example, the statistical method may be that a probability that a relation occurs is counted to be used as the weight.

Another example is provided as follows.

$${s}_{A , B}^{′} ( t ) = {\sum }_{X} ( w ( X ) \cdot {s}_{A , B , X} ( t ) + w ( X ) \cdot {s}_{B , A , X} ( t ) )$$

$${s}_{A , B} ( t ) = \frac{exp ( {s}_{A , B}^{′} ( t ) ) - exp ( - {s}_{A , B}^{′} ( t ) )}{exp ( {s}_{A , B}^{′} ( t ) ) + exp ( - {s}_{A , B}^{′} ( t ) )}$$

A time-series relation graph creating unit 23 creates one graph for the relations for each time unit within the range of the time sequence. The nodes of the graph are the entities, the links between the nodes represent the time-series comprehensive relations between the respective two entities, and the weights of the respective links are the scores of the time-series comprehensive relations between the respective two entities. Thus, an undirected graph with weights is generated for each time unit.

For example, FIGS. 2c and 2e show the time-series relation graphs generated by the relation synthesizing unit 22 and the time-series relation graph creating unit 23, wherein FIG. 2c shows the comprehensive relation graph at time point t₁, and FIG. 2e shows the comprehensive relation graph at time point t₂.

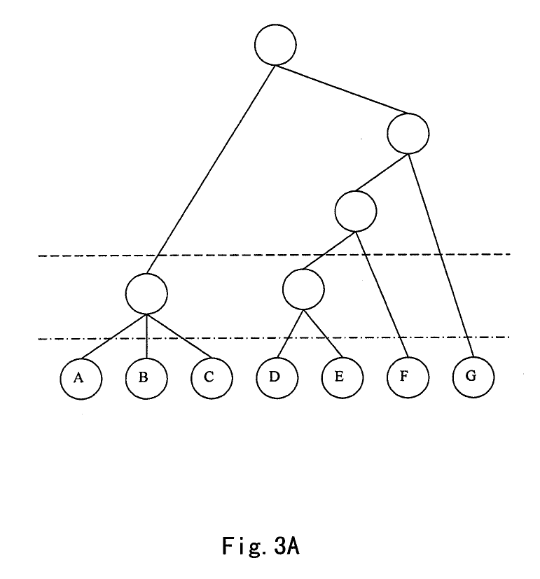

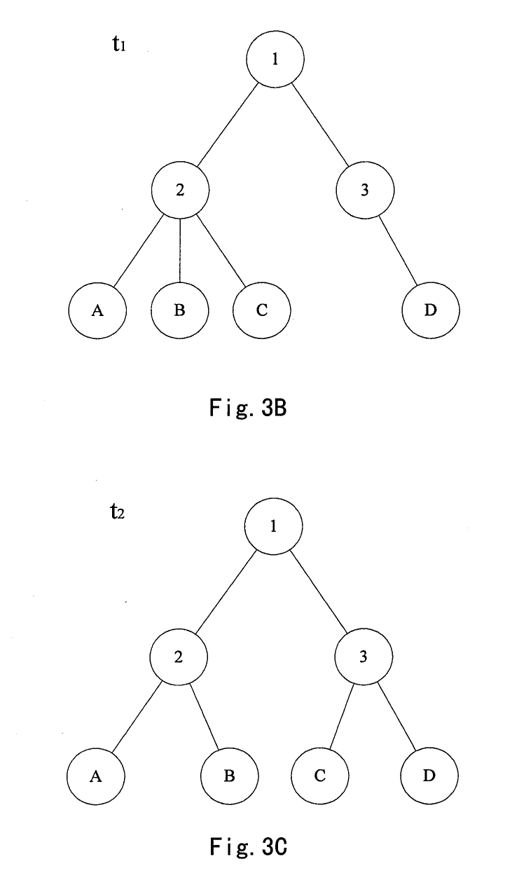

The time-series relation graph categorizing module 3 performs categorization on the nodes in the time-series relation graph for each time unit by using a hierarchical categorizing method. For example, a graph-bipartition-based categorization may be performed on the graph for each time unit by using existing graph based categorizing methods. The existing methods comprise, for example, those described in reference 1, C. H. Ding, X He, H. Zha, M. Gu, and H. D. Simon, A min-max cut algorithm for graph partitioning and data clustering, Proceedings of IEEE ICDM 2001, pp. 107-114, 2001, and in reference 2, J. Shi and J. Malik, Normalized cut and image segmentation, IEEE Trans. on Pattern Analysis and Machine Intelligence, 22(8): 888-905, August 2000. The category result is a bipartite structure of multiple levels. FIG. 3a shows an example of the category result.

In the category result as shown in FIG. 3a, the finest category result comprises 4 categories, that is, A, B and C belong to one category, D and E belong to one category, F belongs to one category, and G belongs to one category. The category result of the upper level comprises 3 categories, that is, A, B and C belong to one category, D, E and F belong to one category, and G belongs to one category. For example, with respect to the business relations, a finer category represents a sub-industry, and a higher level represents an industry.

FIGS. 3b and 3c show the category result at time point t₁ corresponding to FIG. 2c and the category result at time point t₂ corresponding to FIG. 2e, respectively. Specifically, in FIG. 3b, it is shown that at time point t₁, entities A, B and C belong to subcategory 2 and entity D belongs to subcategory 3, and entities A to D all belong to category 1. However, in FIG. 3b, it is shown that at time point t₂, entities A and B belong to subcategory 2 and entities C and D belong to subcategory 3, and entities A to D all belong to category 1.

The category result post-processing module 4 post-processes the time-series category results generated by the time-series relation graph categorizing module 3. It comprehensively processes the category results for all the time units within the prescribed time period to obtain the category result for the prescribed time period.

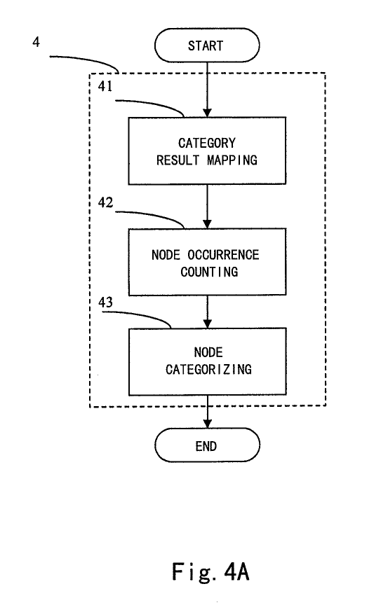

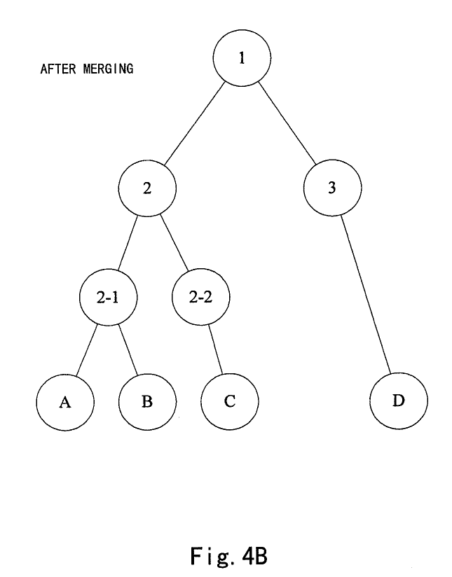

Specifically, FIG. 4a is a block diagram and also a data flow chart showing the category result post-processing module 4.

For each time unit within the prescribed time period, there is one category result such as one shown in FIG. 3. Therefore, there are n category results in total. The category result post-processing module 4 merges these n category results to generate a comprehensive category result.

A category result mapping unit 41 maps each category of the n category graphs by using, for example, a Kuhn-Munkres algorithm (L. Lovasz and M. Plummer, Matching Theory), and finally obtains a category structure merged from the n graphs.

A node occurrence counting unit 42 counts the occurring times of each node in the merged category structure based on the category structure generated by the category result mapping unit 41 and a mapping relation of each category graph therewith.

A node categorizing unit 43 allocates each node to a corresponding category of the merged category structure based on the counting result of the node occurrence counting unit 42.

FIG. 4b shows the merged comprehensive category result corresponding to FIGS. 3b and 3c. Referring to FIG. 4b, the merged comprehensive category result shows that during the time period of t₁+t₂, entities A and B belong to subcategory 2-1, entity C belongs to subcategory 2-2, and entities A, B and C all belong to subcategory 2; entity D belongs to subcategory 3; and entities A to D all belong to category 1.

Example of Categorizing and Analyzing Business Relations

FIG. 1b is an overall block diagram showing a system for categorizing and analyzing time-series business relations. In FIG. 1b, it is shown an example where the present invention is applied to the business relations. Compared with the general system for categorizing and analyzing time-series relations as shown in FIG. 1a, the system shown in FIG. 1b only applies to business relation categorizing and analyzing. Modules 1-4 are identical to those of FIG. 1a, and the repeated description thereof is omitted for the sake of simplicity. Symbol 6 denotes an industry based business event detecting module for performing business event detection on the time-series business relations based on the category results and finally outputting business event results 7.

The business events 7 refer to high-level events derived from an industry analyzing perspective, which have heuristic meanings for users or other corporations. For example, corporation A was a core corporation in its industry from January 1998 to January 2001; corporation B had developed rapidly from January 1999 to January 2000 and so on.

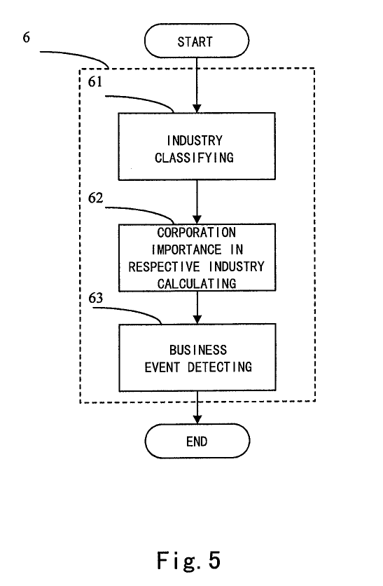

FIG. 5 is a block diagram and also a data flow chart showing the industry based business event detecting module 6.

An industry classifying unit 61 divides all the relations and nodes in terms of industries for each time unit, selects the time-series category results according to an industry subdividing threshold, and for each category (each industry), classifies all the nodes and links in the time-series relation graphs to classify all the corporations and business relations into the respective industries.

A corporation importance calculating unit 62 calculates, for each industry within each time unit, the importances of the respective corporations in the industry. The existing algorithms may be adopted, such as a Page Rank method or an HITS algorithm, or any other feasible methods.

A business event detecting unit 63 selects, for each industry within each time unit, only the corporations and business relations of the industry, and detects the business events in conjunction with the corporation importances.

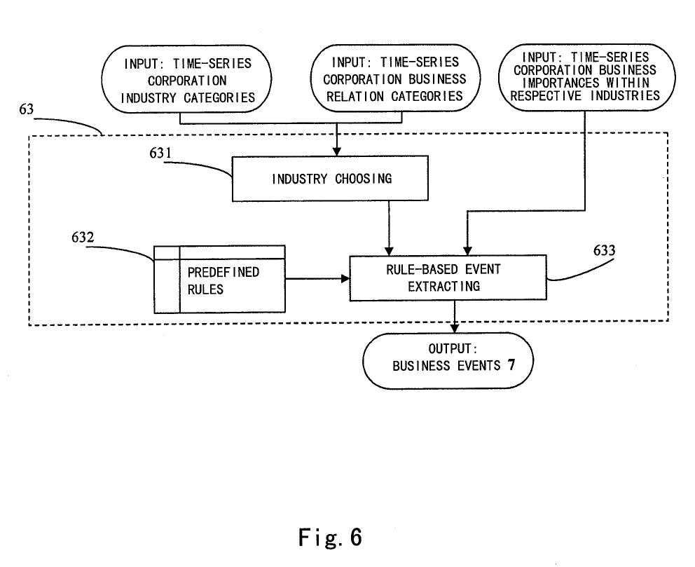

Specifically, FIG. 6 is a block diagram and also a data flow chart showing the business event detecting unit 63. The inputs to the business event detecting unit 63 include the time-series corporation industry categories and the time-series corporation business relation categories generated by the industry classifying unit 61, and the time-series corporation business importances within the respective industries generated by the corporation importance calculating unit 62. An industry choosing sub-unit 631 chooses the corporations and business relations of a prescribed industry from the time-series corporation industry categories and the time-series corporation business relation categories generated by the industry classifying unit 61. A rule-based event extracting sub-unit 633 detects all the input data by means of predefined rules 632, and outputs the business events matching the rules. The predefined rules 632 may be predefined manually. Some examples of the predefined rules 632 are provided as follows.

s_{A}(t) is used to denote the importance of corporation A in a certain industry at time t.

If the business importance of corporation A in a certain industry S_{A}(t)>Th₁,t₀≦t≦t₁, then A is a key corporation in the certain industry from t₀ to t₁;

For corporation A in a certain industry, if

$$\frac{{S}_{A} ( {t}_{1} ) - {S}_{A} ( {t}_{0} )}{{t}_{1} - {t}_{0}} > {Th}_{2} ,$$

then A has developed rapidly in the certain industry from t₀ to t₁;

For corporation A in a certain industry, if

$$\frac{{S}_{A} ( {t}_{0} ) - {S}_{A} ( {t}_{1} )}{{t}_{1} - {t}_{0}} > {Th}_{3} ,$$

then there is something wrong with A in the certain industry from t₀ to t₁;

For corporations A and B in a certain industry, if

$$\frac{{S}_{A , B} ( {t}_{1} ) - {S}_{A , B} ( {t}_{0} )}{{t}_{1} - {t}_{0}} > {Th}_{4} ,$$

then the relation between A and B has developed rapidly from t₀ to t₁;

For corporations A and B in a certain industry, if

$$\frac{{S}_{A , B} ( {t}_{0} ) - {S}_{A , B} ( {t}_{1} )}{{t}_{1} - {t}_{0}} > {Th}_{5} ,$$

then the relation between A and B has deteriorated from t₀ to t₁.

The present invention is described with reference to the preferred embodiments thereof. It is to be understood that, for those skilled in the art, various changes, replacements and additions may be made thereto without departing from the spirit and scope of the invention. Therefore, the scope of the present invention is not limited to those embodiments described above, and is only defined by the appended claims.

Appendix

* relevant contents of attorney docket No. IA078650 (FIG. 3 and the corresponding descriptions of this application document; here, for distinguishing the reference symbols, the symbols in this attachment are added with (″))

Time-series Corporation Relation Extracting Sub-module 22″

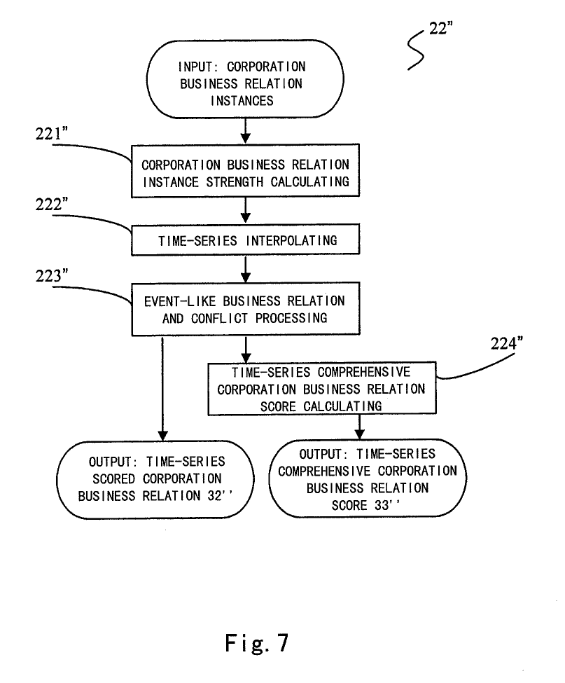

FIG. 7 is a block diagram and also a data flow chart showing the time-series corporation relation extracting sub-module 22″.

A corporation business relation instance strength calculating unit 221″ calculates a strength SI(A,B,X,t) of the corporation business relation of A, B, X within a corresponding time unit of t based on each corporation business relation instance RI(A,B,X,t′).

Within the time unit of t, the corporation business relation instance A, B, X may occur several times. For example, it may be mentioned in different news webs, and may be mentioned several times within t. Cₜ is used to denote the number of times the corporation business relation instance occurs within the time unit of t. Thus, SI(A,B,X,t) may be calculated by the following equation.

$$SI ( A , B , X , t ) = {si}_{A , B , X} ( t ) = {\sum }_{i = 1}^{{C}_{t}} m s ( {n}_{i} )$$

where nᵢ is a corresponding i^{th} instance, ms(n₁) is a matching score of the news of this instance. In fact, the strength is a sum of the scores of all the instants within the time unit of t.

A time-series interpolating unit 222″ calculates a score of a corporation relation, for which no corporation business relation instant occurs during a prescribed period, by interpolation, so that finally any one of continuous relations between any corporations within the prescribed period has its score at any time point. The continuous corporation relation means that the relation continues for a period, while is not a one-time event-like relation. For example, the competition, cooperation, share holding and supply are all continuous business relations. For example, there was no competition relation between corporation A and corporation B in June 2000, but this relation had occurred before in January 2000. Then, the score in June 2000 is calculated by interpolation by using the preceding score of this relation. For example, the method for performing interpolation is as follows.

It is assumed that a relation RI between two corporations first occurs at t₀, and last occurs at tₘ.

For calculating the corporation relation strength at tₘ, it is assumed that an instance occurring just before tₙ occurs at tₖ, and an instance occurring just after tₙ occurs at tₗ, then

$${s}_{A , B , X} ( {t}_{n} ) = \{ \begin{matrix}{si}_{A , B , X} ( {t}_{n} ) & RI ( A , B , X , {t}_{n} ) exists \\ 0 & {t}_{n} < {t}_{0} \\ {si}_{A , B , X} ( {t}_{m} ) \cdot {e}^{- λ ( {t}_{n} - {t}_{m} )} & {t}_{n} > {t}_{m} \\ \begin{matrix}\frac{{t}_{l} - {t}_{n}}{{t}_{l} - {t}_{k}} \cdot {si}_{A , B , X} ( {t}_{k} ) \cdot {e}^{- λ ( {t}_{n} - {t}_{k} )} + \\ \frac{{t}_{n} - {t}_{k}}{{t}_{l} - {t}_{k}} \cdot {si}_{A , B , X} ( {t}_{l} ) \cdot {e}^{- λ ( {t}_{l} - {t}_{n} )}\end{matrix} & {t}_{0} < {t}_{k} < {t}_{n} < {t}_{l} < {t}_{m}\end{matrix}$$

In the above example, the score of the relation exponentially decreases or increases over time. However, as is well-known to those skilled in the art, the variation may be linear decrease or increase over time.

An event-like business relation and conflict processing unit 223″ processes the event-like business relations. The event-like business relations means one-time events rather than continuous business relations. For example, the incorporation and acquisition are both event-like business relations, while the competition, cooperation, share holding and supply are all continuous business relations. The process comprises processing of the scores of such relations per se, processing upon conflict, and processing of other affected relations. For example, the processing method is as follows.

First, the problem of conflict is handled. The solution of conflict is as follows.

Time conflict: Theoretically, the event-like relation should occur only once. However, the information on the Internet is not completely reliable. Therefore, there may be a conflict. If there is a conflict, that is, there are both RI(A,B,X,t₁) and RI(A,B,X,t₂) (t₁<t₂), then an adjusted new corporation relation strength is:

s_{A,B,X}(t₁)=si_{A,B,X}(t₁)+si_{A,B,X}(t₂)

s_{A,B,X}(t₂)=0.

Direction conflict: The direction conflict deals specifically with directional event-like relations such as acquisition. For such relations, there is only one correct direction for two corporations. When there are both RI(A,B,X,t₁) and RI(B,A,X,t₂) (t₁<t₂), if

s_{A,B,X}(t₁)≧s_{B,A,X}(t₂),

then

s_{A,B,X}(t₁)=s_{A,B,X}(t₁)

s_{B,A,X}(t₂)=0;

otherwise

s_{A,B,X}(t₁)=0

s_{B,A,X}(t₂)=s_{B,A,X}(t₂).

Next, the influences on other business relations are handled. If X is a relation of incorporation or acquisition and s_{A,B,X}(t₁)>TH, where TH is a predetermined threshold, then A and B are incorporated into one corporation after t₁, and there is no continuous relation maintained between A and B. After incorporation, the scores of the relations between corporation A (B) and other corporations are adjusted as follows.

s_{A′,C,X}(t)=s_{A,C,X}(t)+s_{B,C,X}(t)

After completing the above process, the event-like business relation and conflict processing unit 223″ outputs the time-series scored corporation business relation 32″.

A time-series comprehensive corporation business relation score calculating unit 224″ calculates the time-series comprehensive business relation score between two corporations and the average total business relation score (in the invention of the attorney docket No. IA078649, there is no need to calculate the time-series comprehensive business relation score, and the calculation of the time-series comprehensive entity relations is achieved by the relation synthesizing unit 22). Specifically, a weighted average of the scores of the various relations is calculated so as to obtain the time-series comprehensive business relation score, that is

s_{A,B}(t)=Σw(X)·s_{A,B,X}(t)

where w(X) is the weight of respective relations, which may be an experience value or may be obtained by a statistical method. The statistical method may be that a probability that a relation occurs in each industry is counted to be used as the weight. Thereafter, the total business relation score is obtained by averaging over all the time. After the process described above, the time-series comprehensive corporation business relation score calculating unit 224″ outputs the time-series comprehensive corporation business relation score 33″.

What is claimed is:

1. An apparatus for categorizing entities based on time-series relation graphs, wherein in each of the time-series relation graphs within a prescribed time period, nodes represent entities, and links between nodes represent entity relations in a corresponding time unit, the apparatus for categorizing entities based on time-series relation graphs comprising:
a time-series relation graph categorizing means for categorizing the nodes in each of the time-series relation graphs to generate a node category result for the corresponding time unit in time sequence; and
a category result post-processing means for post-processing all the node category results for the corresponding time units in time sequence generated by the time-series relation graph categorizing means to generate finally categorized nodes.

2. The apparatus for categorizing entities based on time-series relation graphs according to claim 1, wherein further comprising:
a time-series relation graph generating means for processing inputted relation instances to generate corresponding time-series relation graphs.

3. The apparatus for categorizing entities based on time-series relation graphs according to claim 2, wherein the time-series relation graph generating means comprises:
a time-series relation generating unit for calculating scores for the relation instances, resolving internal conflicts, performing interpolation on absent time points, to obtain time-series relations;
a relation synthesizing unit for synthesizing various types of the time-series relations among entities generated by the time-series relation generating unit to obtain respective time-series comprehensive relations between respective two entities; and
a time-series relation graph creating unit for creating one graph for the relations for each time unit within the prescribed time period so as to form the time-series relation graphs.

4. The apparatus for categorizing entities based on time-series relation graphs according to claim 3, wherein the respective time-series comprehensive relations between respective two entities generated by the relation synthesizing unit are undirected.

5. The apparatus for categorizing entities based on time-series relation graphs according to claim 3, wherein in the relation graphs created by the time-series relation graph creating unit, the nodes represent the entities, the links between nodes represent the respective time-series comprehensive relations between respective two entities, and weights of the respective links represent the scores of the respective time-series comprehensive relations between respective two entities.

6. The apparatus for categorizing entities based on time-series relation graphs according to claim 3, wherein the time-series relation graph generating means generates one undirected graph with weights for each time unit.

7. The apparatus for categorizing entities based on time-series relation graphs according to claim 1, wherein the time-series relation graph categorizing means performs categorization on the nodes in the time-series relation graph for each time unit by using a hierarchical categorizing method.

8. The apparatus for categorizing entities based on time-series relation graphs according to claim 1, wherein the category result post-processing means comprises:
a category result mapping unit for mapping each category of all the node category results for the corresponding time units in time sequence generated by the time-series relation graph categorizing means to obtain a merged node category structure;
a node occurrence counting unit for counting, for each category of the merged node category structure, the occurring times of each node therein based on the merged node category structure generated by the category result mapping unit and a mapping relation of each node category result therewith; and
a node categorizing unit for allocating each node to a corresponding category of the merged node category structure based on the counting result of the node occurrence counting unit.

9. The apparatus for categorizing entities based on time-series relation graphs according to claim 8, wherein the category result mapping unit performs the category mapping by using a Kuhn-Munkres algorithm.

10. The apparatus for categorizing entities based on time-series relation graphs according to claim 1, wherein the category result post-processing means further generates a merged node category result, and
the apparatus for categorizing entities based on time-series relation graphs further comprises:
an event detecting means for performing event detection on the entity relations based on the merged node category result and outputting event results.

11. The apparatus for categorizing entities based on time-series relation graphs according to claim 10, wherein the event detecting means comprises:
a category classifying unit for dividing all the entities and relations in terms of categories for each time unit, selecting the node category result for the corresponding time unit in time sequence according to a predetermined category subdividing threshold, and for each category of the selected category result, classifying all the nodes and links in the time-series relation graphs to classify all the entities and relations into respective categories;
an entity importance calculating unit for calculating, for each category within each time unit, time-series entity importances of the respective entities therein; and
an event detecting unit for selecting, for each category within each time unit, the entities and relations of the present category, and detecting the events in conjunction with the time-series entity importances.

12. The apparatus for categorizing entities based on time-series relation graphs according to claim 11, wherein the entity importance calculating unit calculates the entity importances by using a Page Rank method or an HITS algorithm.

13. The apparatus for categorizing entities based on time-series relation graphs according to claim 11, wherein the event detecting unit comprises:
a category choosing sub-unit for choosing entities and relations of a prescribed category from the time-series categorized entities and relations generated by the category classifying unit; and
a rule-based event extracting sub-unit for detecting and outputting the events matching predefined rules based on the predefined rules, the chosen result of the category choosing sub-unit, and time-series entity importances of the respective entities within the respective categories generated by the entity importance calculating unit.

14. The apparatus for categorizing entities based on time-series relation graphs according to claim 1, wherein the entities are corporations, the relations are business relations, and the categories are industries.

15. An method for categorizing entities based on time-series relation graphs, wherein in each of the time-series relation graphs within a prescribed time period, nodes represent entities, and links between nodes represent entity relations in a corresponding time unit, the method for categorizing entities based on time-series relation graphs comprising:
a time-series relation graph categorizing step of categorizing the nodes in each of the time-series relation graphs to generate a node category result for the corresponding time unit in time sequence; and
a category result post-processing step of post-processing all the node category results for the corresponding time units in time sequence generated in the time-series relation graph categorizing step to generate finally categorized nodes.

16. The method for categorizing entities based on time-series relation graphs according to claim 15, wherein further comprising:
a time-series relation graph generating step of processing inputted relation instances to generate corresponding time-series relation graphs.

17. The method for categorizing entities based on time-series relation graphs according to claim 16, wherein the time-series relation graph generating step comprises:
a time-series relation generating sub-step of calculating scores for the relation instances, resolving internal conflicts, performing interpolation on absent time points, to obtain time-series relations;
a relation synthesizing sub-step of synthesizing various types of the time-series relations among entities generated in the time-series relation generating sub-step to obtain respective time-series comprehensive relations between respective two entities; and
a time-series relation graph creating sub-step of creating one graph for the relations for each time unit within the prescribed time period so as to form the time-series relation graphs.

18. The method for categorizing entities based on time-series relation graphs according to claim 17, wherein the respective time-series comprehensive relations between respective two entities generated in the relation synthesizing sub-step are undirected.

19. The method for categorizing entities based on time-series relation graphs according to claim 17, wherein in the relation graphs created in the time-series relation graph creating sub-step, the nodes represent the entities, the links between nodes represent the respective time-series comprehensive relations between respective two entities, and weights of the respective links represent the scores of the respective time-series comprehensive relations between respective two entities.

20. The method for categorizing entities based on time-series relation graphs according to claim 17, wherein in the time-series relation graph generating step, one undirected graph with weights is generated for each time unit.

21. The method for categorizing entities based on time-series relation graphs according to claim 15, wherein in the time-series relation graph categorizing step, categorization on the nodes in the time-series relation graph for each time unit is performed by using a hierarchical categorizing method.

22. The method for categorizing entities based on time-series relation graphs according to claim 15, wherein the category result post-processing step comprises:
a category result mapping sub-step of mapping each category of all the node category results for the corresponding time units in time sequence generated in the time-series relation graph categorizing step to obtain a merged node category structure;
a node occurrence counting sub-step of counting, for each category of the merged node category structure, the occurring times of each node therein based on the merged node category structure generated in the category result mapping sub-step and a mapping relation of each node category result therewith; and
a node categorizing sub-step of allocating each node to a corresponding category of the merged node category structure based on the counting result of the node occurrence counting sub-step.

23. The method for categorizing entities based on time-series relation graphs according to claim 22, wherein in the category result mapping sub-step, the category mapping is performed by using a Kuhn-Munkres algorithm.

24. The method for categorizing entities based on time-series relation graphs according to claim 15, wherein in the category result post-processing step, a merged node category result is further generated, and
the method for categorizing entities based on time-series relation graphs further comprises:
an event detecting step of performing event detection on the entity relations based on the merged node category result and outputting event results.

25. The method for categorizing entities based on time-series relation graphs according to claim 24, wherein the event detecting step comprises:
a category classifying sub-step of dividing all the entities and relations in terms of categories for each time unit, selecting the node category result for the corresponding time unit in time sequence according to a predetermined category subdividing threshold, and for each category of the selected category result, classifying all the nodes and links in the time-series relation graphs to classify all the entities and relations into respective categories;
an entity importance calculating sub-step of calculating, for each category within each time unit, time-series entity importances of the respective entities therein; and
an event detecting sub-step of selecting, for each category within each time unit, the entities and relations of the present category, and detecting the events in conjunction with the time-series entity importances.

26. The method for categorizing entities based on time-series relation graphs according to claim 25, wherein in the entity importance calculating sub-step, the entity importances are calculated by using a Page Rank method or an HITS algorithm.

27. The method for categorizing entities based on time-series relation graphs according to claim 25, wherein the event detecting sub-step comprises:
a category choosing sub-sub-step of choosing entities and relations of a prescribed category from the time-series categorized entities and relations generated in the category classifying sub-step; and
a rule-based event extracting sub-sub-step of detecting and outputting the events matching predefined rules based on the predefined rules, the chosen result of the category choosing sub-sub-step, and time-series entity importances of the respective entities within the respective categories generated in the entity importance calculating sub-step.

28. The method for categorizing entities based on time-series relation graphs according to claim 15, wherein the entities are corporations, the relations are business relations, and the categories are industries.
